(19) United States
(12) Patent Application Publication
(10) Pub. No.: US 2024/0410598 A1
(43) Pub. Date: Dec. 12, 2024

(54) AIR CONDITIONING DEVICE

(71) Applicant: DENSO CORPORATION, Kariya-city (JP)

(72) Inventors: Yasuhiro SEKITO, Kariya-city (JP); Shinya Kato, Kariya-city (JP); Ryo Kobayashi, Kariya-city (JP)

(21) Appl. No.: 18/808,526

(22) Filed: Aug. 19, 2024

Related U.S. Application Data
(63) Continuation of application No. PCT/JP2023/011053, filed on Mar. 21, 2023.

(30) Foreign Application Priority Data
Mar. 25, 2022 (JP) 2022-050175
Nov. 24, 2022 (JP) 2022-187597

(51) Int. Cl. F24F 1/0018

(52) U.S. Cl. CPC F24F 1/0018

(57) ABSTRACT

An air conditioning device includes an air conditioning case defining an air passage through which air flows to an air-conditioning target space, and an air cooler arranged inside the air conditioning case to cool air by absorbing heat from air. The air conditioning device further includes a blower fan arranged inside the air conditioning case on a downstream side of an air flow of the air cooler to generate an air flow passing through the air cooler, and a resonator provided outside the air passage. The resonator includes a cavity portion having a predetermined volume and a communication portion that allows communication between the cavity portion and the air passage. The cavity portion is provided with a partition member that divides an internal space of the cavity portion into multiple closed spaces, and each of the multiple closed spaces communicates with the air passage via the communication portion.

### CROSS REFERENCE TO RELATED APPLICATIONS

The present application is a continuation application of International Patent Application No. PCT/JP2023/011053 filed on Mar. 21, 2023, which designated the U.S. and claims the benefit of priority from Japanese Patent Application No. 2022-050175 filed on Mar. 25, 2022, and Japanese Patent Application No. 2022-187597 filed on Nov. 24, 2022. The entire disclosures of all of the above applications are incorporated herein by reference.

### TECHNICAL FIELD

The present disclosure relates to an air conditioning device.

### BACKGROUND

Conventionally, an air conditioning device is known, in which a blower fan is arranged inside an air conditioning device case, downstream of an air flow of an evaporator that serves as an air cooler.

### SUMMARY

According to an aspect of the present disclosure, an air conditioning device includes: an air conditioning case defining an air passage through which a ventilation air flows to an air-conditioning target space; an air cooler arranged inside the air conditioning case to cool the ventilation air by absorbing heat from the ventilation air; a blower fan arranged inside the air conditioning case on a downstream side of an air flow of the air cooler, to generate an air flow passing through the air cooler; and a resonator provided outside of the air passage. The resonator includes a cavity portion having a predetermined volume, and a communication portion through which the cavity portion and the air passage communicate with each other. Furthermore, the cavity portion is provided with a partition member that divides an internal space of the cavity portion into multiple closed spaces, and each of the multiple closed spaces is configured to communicate with the air passage via the communication portion.

According to another aspect of the present disclosure, an air conditioning device includes: an air conditioning case defining an air passage through which a ventilation air flows to an air-conditioning target space; a blower fan arranged inside the air conditioning case to generate an air flow passing through the air passage; and a resonator provided outside the air passage. The resonator includes a cavity portion having a predetermined volume, and a communication portion through which the cavity portion communicates with a downstream side of the air flow of the blower fan in the air passage. The cavity portion is provided with a partition member that divides an internal space of the cavity portion into multiple closed spaces, and each of the multiple closed spaces is configured to communicate with the air passage via the communication portion.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic diagram of a vehicle air conditioning device according to a first embodiment;

FIG. 2 is a cross-sectional view taken along the II-II line in FIG. 1;

FIG. 3 is a cross-sectional view taken along the III-III line in FIG. 2;

FIG. 4 is an explanatory diagram to explain a noise suppression effect of a resonator;

FIG. 5 is a schematic cross-sectional view of the resonator for the vehicle air conditioning device in a modification example of the first embodiment;

FIG. 6 is a schematic cross-sectional view of a resonator of a vehicle air conditioning device according to a second embodiment;

FIG. 7 is an explanatory diagram to explain a noise suppression effect of the resonator in a face mode;

FIG. 8 is an explanatory diagram to explain a noise suppression effect of the resonator in a foot mode;

FIG. 9 is a schematic cross-sectional view of a resonator for a vehicle air conditioning device according to a modification example of the second embodiment;

FIG. 10 is a schematic cross-sectional view of a resonator of a vehicle air conditioning device in a third embodiment;

FIG. 11 is a schematic cross-sectional view of a resonator for a vehicle air conditioning device according to a modification example of the third embodiment; and

FIG. 12 is a schematic diagram of a vehicle air conditioning device in a fourth embodiment.

### DETAILED DESCRIPTION

For example, in an air conditioning device in which a blower fan is arranged downstream of an air cooler, when the blower fan is positioned close to a target space to which a ventilation air is to be blown, noise of the air conditioning device easily reaches the target space. Such a situation is observed notably when the blower fan is arranged downstream of an air cooler, but can occur whether or not an air cooler is present.

It is an object of the present disclosure is to provide an air conditioning device capable of suppressing noise.

According to an aspect of the present disclosure, an air conditioning device includes: an air conditioning case defining an air passage through which a ventilation air flows to an air-conditioning target space; an air cooler arranged inside the air conditioning case to cool the ventilation air by absorbing heat from the ventilation air; a blower fan arranged inside the air conditioning case on a downstream side of an air flow of the air cooler, to generate an air flow passing through the air cooler; and a resonator provided outside of the air passage. The resonator includes a cavity portion having a predetermined volume, and a communication portion through which the cavity portion and the air passage communicate with each other. Furthermore, the cavity portion is provided with a partition member that divides an internal space of the cavity portion into multiple closed spaces, and each of the multiple closed spaces is configured to communicate with the air passage via the communication portion.

According to the above, the resonator is arranged adjacent to the air passage inside the air conditioning case, thereby preventing noise of the air conditioning device from reaching the air-conditioning target space. In particular, since the internal space of the cavity portion is divided into multiple closed spaces, noise from the air conditioning device is prevented from reaching the air-conditioning target space, even in case in which multiple types of noise with different frequencies are present. Therefore, according to the air conditioning device of the present disclosure, even if the blower fan is arranged downstream of the air cooler, the noise of the air conditioning device can be effectively suppressed.

For example, the resonator may be arranged at an upstream side of the blower fan in the air flow. In addition, the communication portion is open toward downstream in the air flow to cause each of the multiple closed spaces of the resonator to communicates with the downstream side of the air flow of the blower fan in the air passage through the communication portion while without directly communicating with an upstream side of the air flow of the blower fan through the communication portion.

According to another aspect of the present disclosure, an air conditioning device includes: an air conditioning case defining an air passage through which a ventilation air flows to an air-conditioning target space; a blower fan arranged inside the air conditioning case to generate an air flow passing through the air passage; and a resonator provided outside the air passage. The resonator includes a cavity portion having a predetermined volume, and a communication portion through which the cavity portion communicates with at least a downstream side of the air flow of the blower fan in the air passage. The cavity portion is provided with a partition member that divides an internal space of the cavity portion into multiple closed spaces, and each of the multiple closed spaces is configured to communicate with the air passage via the communication portion.

According to the above, the resonator is arranged adjacent to the air passage inside the air conditioning case, thereby preventing noise of the air conditioning device from reaching the air-conditioning target space. In particular, since the internal space of the cavity portion is divided into multiple closed spaces, noise from the air conditioning device is prevented from reaching the air-conditioning target space, even in case in which multiple types of noise with different frequencies are present. In addition, the resonator, which is arranged to reduce noise generated in a section of the air passage from the blower fan to the air-conditioning target space, is capable of suppressing noise generated downstream of the air flow of the blower fan. Therefore, according to the air conditioning device of the present disclosure, noise can be effectively suppressible even when the blower fan is arranged in a position close to the air-conditioning target space.

Hereinafter, embodiments of the present disclosure will be described with reference to the drawings. In the following embodiments, components that are the same as or equivalent to those described in the preceding embodiment(s) will be indicated by the same reference symbols, and the description thereof may be omitted. In the following embodiments, when only partial configuration is described in one embodiment, remaining configuration may adopt same configurations as those described in the preceding embodiments. The following embodiments may be partially combined with each other even if such a combination is not explicitly described as long as there is no disadvantage with respect to such a combination.

### FIRST EMBODIMENT

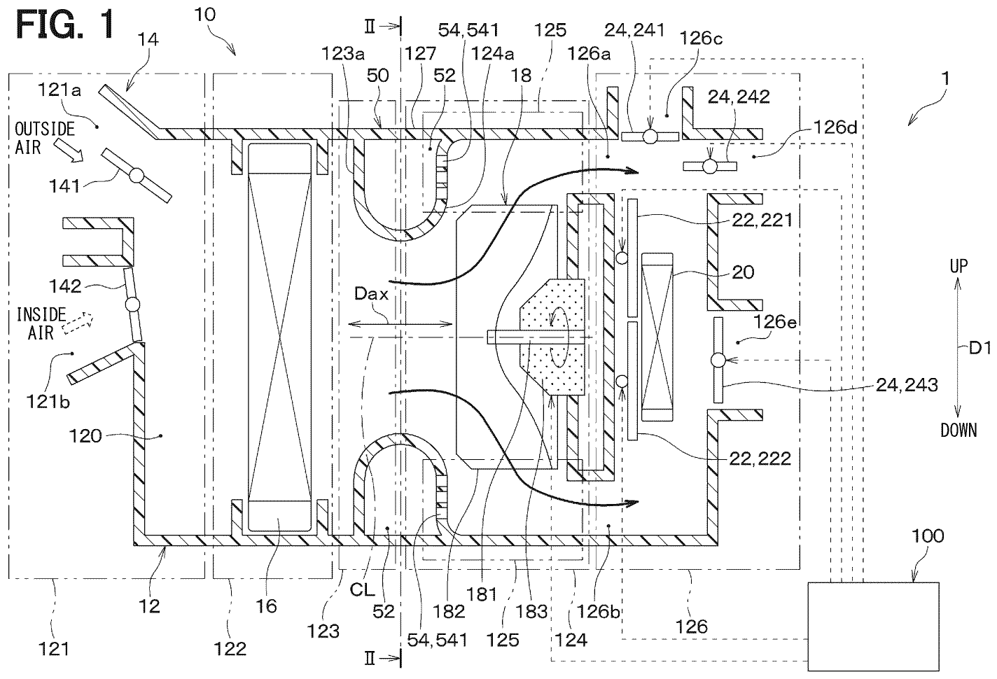

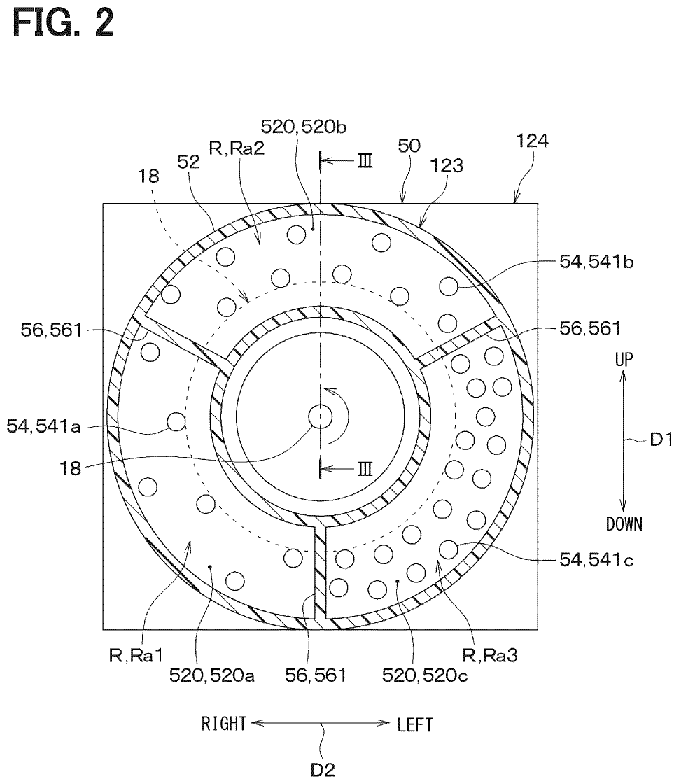

The present embodiment will be described with reference to FIGS. 1 to 4. In the present embodiment, an example in which an air conditioning device according to the present disclosure is applied to a vehicle air conditioning device 1 mounted on a vehicle will be described. The vehicle air conditioning device 1 shown in FIG. 1 adjusts temperature inside a vehicle cabin by blowing air adjusted to a desired temperature into the vehicle cabin, which is an air-conditioning target space. An arrow indicating up and down in FIG. 1 and the like indicates an up-down direction D1 in a state in which the vehicle air conditioning device 1 is mounted on a vehicle. An arrow indicating left and right in FIG. 2 and the like indicates a left-right direction D2 in a state in which the vehicle air conditioning device 1 is mounted on the vehicle.

The vehicle air conditioning device 1 includes a cabin air conditioning unit 10 and an air conditioning control device 100. The cabin air conditioning unit 10 is arranged inside an instrument panel that is arranged at a frontmost part of the vehicle cabin.

The cabin air conditioning unit 10 includes an air conditioning case 12, an inside/outside air switcher 14, an evaporator 16, a blower fan 18, a heater core 20, an air mix door 22, a mode switching door 24, and the like. The cabin air conditioning unit 10 is configured as a suction type unit in which the blower fan 18 is arranged downstream of the air flow of the evaporator 16.

The air conditioning case 12 forms an air passage 120 through which air flows to be blown into the vehicle cabin. The air conditioning case 12 is made of a material (such as polypropylene) that has a certain degree of elasticity and excellent strength. The air conditioning case 12 includes an air inlet 121, a first housing 122, a fan connector 123, a second housing 124, and an air outlet 126.

The air inlet 121 is a portion of the air conditioning case 12 where the inside/outside air switcher 14 is arranged. The air inlet 121 has an outside air intake port 121a for introducing outside air and an inside air intake port 121b for introducing inside air. Opening area sizes of the outside air intake port 121a and the inside air intake port 121b are continuously adjusted by an outside air door 141 and an inside air door 142 that constitute the inside/outside air switcher 14. The outside air door 141 and the inside air door 142 may be configured as a plate door, or may be configured as other doors such as a rotary door, a sliding door or the like. Further, the outside air door 141 and the inside air door 142 may be configured as separate components, or may be configured to have an integral, one-piece body.

The first housing 122 is connected to the air inlet 121 on the downstream side of the air flow. The first housing 122 is a portion that houses the evaporator 16 therein. The first housing 122 is configured as a rectangular tube having a substantially rectangular outer shape so that the evaporator 16 having a flattened rectangular parallelepiped shape can be housed therein.

The evaporator 16 constitutes a vapor compression refrigeration cycle together with a compressor, a radiator, an expansion valve, and the like (not shown). The evaporator 16 is a heat exchanger that evaporates a refrigerant flowing inside the evaporator 16 by exchanging heat with ventilation air. In the evaporator 16, the refrigerant absorbs heat from the ventilation air, thereby cooling the ventilation air. In the present embodiment, the evaporator 16 serves as an “air cooler.” The evaporator 16 is arranged inside the first housing 122 so that all of the air flowing inside the first housing 122 passes through the evaporator 16.

The second housing 124 is connected to a downstream side of the air flow of the first housing 122 via the fan connector 123. The second housing 124 is a portion that houses the blower fan 18 therein. Similar to the first housing 122, the second housing 124 is configured as a rectangular tube having a substantially rectangular outer shape.

The second housing 124 includes a guide wall 124a extending in a direction intersecting an axial direction Dax. The guide wall 124a has an upstream end in the air flow direction connected to a bell mouth 123a, which will be described later. A part of the air blown out from the blower fan 18 flows downstream along the guide wall 124a. The blower fan 18 is arranged inside the air conditioning case 12 on the downstream side of the air flow of the evaporator 16. The blower fan 18 generates an airflow that passes through the evaporator 16. The blower fan 18 includes a shaft 181 serving as a rotation axis, an impeller 182 that rotates integrally with the shaft 181, an electric motor 183, and the like. The blower fan 18 in the present embodiment is a centrifugal fan that draws in air in the axial direction Dax along an axis CL of the shaft 181, and blows out the air in a direction away from the axis CL of the shaft 181.

Here, the second housing 124 includes a fan outlet 125 through which the air blown out from the blower fan 18 passes. The fan outlet 125 is a portion of the second housing 124 that is arranged on an outer side of the blower fan 18. The fan outlet 125 is provided to overlap with the blower fan 18 in a direction away from the axis CL.

In the fan outlet 125, noise becomes particularly noticeable due to periodic pressure fluctuations caused by rotation of the blower fan 18. Therefore, a resonator 50 is provided adjacent to the fan outlet 125. The resonator 50 will be described later.

The fan connector 123 is a portion that connects the first housing 122 and the second housing 124. The fan connector 123 is a portion that guides the air having passed through the evaporator 16 to an air suction side of the blower fan 18. The fan connector 123 is configured as a rectangular tube with a roughly rectangular portion at a connection portion with the first housing 122, and changes from the rectangular tube to a shape closer to a cylinder as it approaches the second housing 124.

Specifically, the fan connector 123 has an inner passage that narrows toward a downstream side, forming a throttle shape. That is, an inner cross-sectional area size of the fan connector 123 becomes smaller as it approaches the second housing 124. The fan connector 123 has the bell mouth 123a formed at a connection portion with the second housing 124. The bell mouth 123a has a shape that protrudes toward an inside of the air conditioning case 12 from a wall portion that extends along an air flow direction of the air conditioning case 12. The bell mouth 123a has a substantially circular ring shape when viewed from the air flow direction. The passage inside the fan connector 123 is narrowed at a position close to the blower fan 18 by the bell mouth 123a.

By configuring the air conditioning case 12 in the above-described manner, a space that does not contribute to air flow is formed at a position between the fan connector 123 and the second housing 124. Specifically, in the air conditioning case 12, a space that does not contribute to air flow is formed at a position between the bell mouth 123a of the fan connector 123 and the guide wall 124a of the second housing 124. The air that has passed through the evaporator 16 is guided by the bell mouth 123a and is sucked into the blower fan 18.

The air outlet 126 is connected to a downstream side of the air flow of the second housing 124. The air outlet 126 is a portion that guides the air blown out from the blower fan 18 to the outside of the air conditioning case 12.

The heater core 20 is arranged in the air outlet 126. The heater core 20 is arranged downstream of the air flow of the blower fan 18. The heater core 20 is a radiator that radiates heat from (a) cooling water that cools on-board devices that generate heat when the vehicle is in use, (b) high-temperature, high-pressure refrigerant that flows in a refrigeration cycle, and the like, to the ventilation air. The air flowing into the heater core 20 is heated when passing through the heater core 20 and the temperature of the air rises.

In the air outlet 126, cool air bypass passages 126a, 126b are formed above and below the heater core 20, allowing the air to flow bypassing the heater core 20. Further, the air mix door 22 is arranged in the air outlet 126. The air mix door 22 adjusts a ratio of (i) the volume of the air passing through the heater core 20 to (ii) the volume of the air passing through the cool air bypass passages 126a, 126b, thereby adjusting the temperature of the air blown into the vehicle cabin. The air mix door 22 is made of two slide doors 221 and 222 that move along an air inlet surface of the heater core 20. The air mix door 22 may be formed by another type of door, such as a plate door or the like.

Together with a defroster opening 126c, a face opening 126d, and a foot opening 126e formed as blow-out openings on an air flow downstream side of the heater core 20 in the air outlet 126, the mode switching door 24 is arranged at such a position.

The defroster opening 126c is an opening for blowing out ventilation air toward an inside of a window glass in a front part of the vehicle. The defroster opening 126c communicates with a defroster air outlet via a duct (not shown). The defroster opening 126c is opened and closed by a defroster door 241 included in the mode switching door 24.

The face opening 126d is an opening for blowing out ventilation air toward an upper half of a body of a user sitting in a front seat inside the vehicle cabin. The face opening 126d communicates with a face air outlet via a duct (not shown). The face opening 126d is opened and closed by a face door 242 included in the mode switching door 24.

The foot opening 126e is an opening for blowing out ventilation air toward a lower half of the body of the user seated in the front seat inside the vehicle cabin. The foot opening 126e communicates with a foot air outlet via a duct (not shown). The foot opening 126e is opened and closed by a foot door 243 included in the mode switching door 24.

The operation of the cabin air conditioning unit 10 is controlled by the air conditioning control device 100. The air conditioning control device 100 is composed of a microcomputer including a processor, a memory, and the like, and its peripheral circuits. The air conditioning control device 100 performs various calculation processes based on an air conditioning control program stored in the memory, and controls the operation of various devices connected to an output side. To an input side of the air conditioning control device 100, various air conditioning control sensors and an air conditioning operation panel (not shown). To the output side of the air conditioning control device 100, various control devices such as the blower fan 18, the air mix door 22, the mode switching door 24, and the like are connected.

The vehicle air conditioning device 1 generates noise during operation. For example, noise is generated by periodic pressure fluctuations of the ventilation air flowing inside the air conditioning case 12. Such a noise includes what is called NZ noise, which is generated due to the rotation of the blower fan 18. The NZ noise becomes noticeable at a fundamental frequency corresponding to a product NZ of a rotation speed N of the blower fan 18 and a number Z of its blades, and also at integer multiples of the fundamental frequency. In particular, in the vehicle air conditioning device 1 of the present embodiment, since the blower fan 18 is arranged downstream of the evaporator 16, noise from the vehicle air conditioning device 1 is likely to reach the vehicle cabin. Taking these factors into consideration, in the vehicle air conditioning device 1 of the present embodiment, the resonator 50 for suppressing noise is provided outside the air passage 120.

The resonator 50 is a device having a sound absorbing mechanism of a Helmholtz type. The resonator 50 includes (i) a cavity portion 52 having a predetermined volume and (ii) a communication portion 54 that allows communication between the cavity portion 52 and the air passage 120. The resonator 50 can absorb sound of a frequency corresponding to a resonance frequency f by resonating the air in the communication portion 54 with an air layer in the cavity portion 52.

Here, the resonance frequency f can be calculated by the following formula F1.

f=c[P/{(t+0.8×ϕ)×H}]^{1/2}/2π (F1)

In the formula F1, a speed of sound is represented by “c”, an opening ratio of a through hole 541 described later is represented by “P”, a diameter of the through hole 541 is represented by “ϕ”, the thickness of a portion where the through hole 541 is represented by provided is represented by “t”, and a depth of a closed space 520 is represented by “H”. Here, the opening ratio of the through hole 541 can be calculated from an interval between adjacent through holes 541 and the diameter of the through holes 541.

The cavity portion 52 of the resonator 50 is set by utilizing a space in the air conditioning case 12 that does not contribute to air flow. The cavity portion 52 in the present embodiment is formed at a position between the fan connector 123 and the second housing 124 in the air conditioning case 12. Specifically, the cavity portion 52 is defined by the bell mouth 123a of the fan connector 123, the guide wall 124a of the second housing 124, and an outer wall 127 that constitutes an outer shell of the air conditioning case 12. The cavity portion 52 communicates with the air passage 120 via the communication portion 54.

Here, inside the air conditioning case 12, the pressure fluctuations of the air are greater on an air outlet side of the blower fan 18 than on an air suction side of the blower fan 18, which make the noise more noticeable on the air outlet side of the blower fan 18.

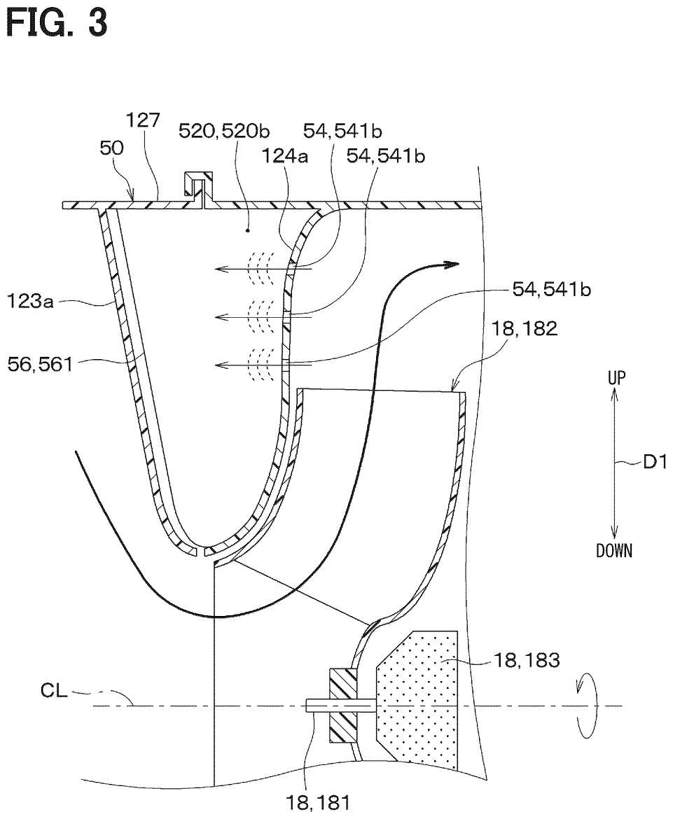

Taking such a factor into consideration, the communication portion 54 of the resonator 50 is provided at a position adjacent to the cavity portion 52 in the fan outlet 125. Specifically, as shown in FIGS. 2 and 3, the communication portion 54 is formed at a portion of the guide wall 124a that is arranged on a radial-outer side than the blower fan 18. The communication portion 54 in the present embodiment is constituted by multiple through holes 541 provided on the air conditioning case 12. The multiple through holes 541 penetrate the guide wall 124a from the outside to the inside.

As shown in FIG. 2, the cavity portion 52 is provided with partition members 56 that divide the internal space of the cavity portion 52 into multiple closed spaces 520. Each of the multiple closed spaces 520 is structured to communicate with the air passage 120 via the communication portion 54.

In the present embodiment, the cavity portion 52 is partitioned by a partition member 56 into three closed spaces 520, namely, a first space 520a, a second space 520b, and a third space 520c. The cavity portion 52 may be equi-volumetrically divided into a first space 520a, a second space 520b, and a third space 520c respectively having equal volumes, or may be divided into spaces having respectively different volumes.

The partition member 56 includes a rib 561 provided on the air conditioning case 12. As shown in FIG. 3, the rib 561 is provided on a second housing 124 side of the air conditioning case 12, and protrudes towards a first housing 122 side. Specifically, the rib 561 is elected on the guide wall 124a so that a tip of the rib 561 abuts against the bell mouth 123a of the fan connector 123. Such a configuration prevents adjacent closed spaces 520 on a second housing 124 side from communicating with each other.

In the resonator 50 of the present embodiment, multiple resonance portions R are formed by the multiple closed spaces 520 and the multiple through holes 541. The resonator 50 of the present embodiment is provided with a first resonance portion Ra1, a second resonance portion Ra2, and a third resonance portion Ra3. The first resonance portion Ra1 is formed by the first space 520a and a through hole 541a. The second resonance portion Ra2 is formed by the second space 520b and a through hole 541b. The third resonance portion Ra3 is formed by the third space 520c and a through hole 541c.

The first resonance portion Ra1, the second resonance portion Ra2, and the third resonance portion Ra3 are configured to have respectively different resonance frequencies f. According to the above-mentioned formula F1, the larger the opening ratio is, the higher the resonance frequency f becomes, and the smaller the opening ratio is, the lower the resonance frequency f becomes. The first resonance portion Ra1, the second resonance portion Ra2, and the third resonance portion Ra3 have different opening ratios so that they have respectively different resonance frequencies f.

In the first resonance portion Ra1, the second resonance portion Ra2, and the third resonance portion Ra3 of the present embodiment, the opening ratio of the through hole 541 is set so that the resonance frequency f corresponds to the frequency of the NZ noise. Specifically, the opening ratio of the through hole 541a is set so that the resonance frequency f of the first resonance portion Ra1 corresponds to a frequency of a primary component of the NZ noise. In addition, the opening ratio of the through hole 541b is set so that the resonance frequency f of the second resonance portion Ra2 corresponds to a frequency of a secondary component of the NZ noise. Further, the opening ratio of the through hole 541c is set so that the resonance frequency f of the third resonance portion Ra3 corresponds to a frequency of a third-order component of the NZ noise. Basically, the opening ratio of the second resonance portion Ra2 is larger than the opening ratio of the first resonance portion Ra1 and smaller than the opening ratio of the third resonance portion Ra3. However, when the depths of the closed spaces 520 of the resonance portions Ra1, Ra2, and Ra3 are different, the above-described relationship may be not necessarily satisfied.

The vehicle air conditioning device 1 described above includes the air conditioning case 12 that constitutes the air passage 120 through which ventilation air flows, the evaporator 16 that cools the ventilation air, the blower fan 18 that is arranged downstream of the air flow of the evaporator 16, and the resonator 50 that is provided outside the air passage 120. The resonator 50 includes the cavity portion 52 having a predetermined volume and the communication portion 54 that allows communication between the cavity portion 52 and the air passage 120. The cavity portion 52 is provided with the partition member 56 that divides the internal space of the cavity portion 52 into the multiple closed spaces 520, and each of the multiple closed spaces 520 is in communication with the air passage 120 via the communication portion 54.

According to the above, the resonator 50 arranged adjacent to the air passage 120 inside the air conditioning case 12 prevents noise of the vehicle air conditioning device 1 from reaching the vehicle cabin, which is the air-conditioning target space. In particular, since the internal space of the cavity portion 52 is divided into the multiple closed spaces 520, the noise of the vehicle air conditioning device 1 is prevented from reaching the vehicle cabin even when multiple types of noise with different frequencies are present. Therefore, according to the vehicle air conditioning device 1 of the present embodiment, even when the blower fan 18 is arranged downstream of the evaporator 16, the noise of the vehicle air conditioning device 1 is effectively prevented from reaching the vehicle cabin.

Specifically, the vehicle air conditioning device 1 of the present embodiment is provided with the closed space 520 partitioned into multiple compartments and the communication portion 54 at a position near a wall surface of the air conditioning case 12, i.e., near the blower fan 18 serving as a sound generator. Therefore, noise having multiple frequency components generated in the vicinity of the blower fan 18 is suppressible all at once, while individually suppressing noise having various frequency components generated in various operating modes of the blower fan 18. Further, by devising a structure that arranges the closed space 520 adjacent to the air passage 120, a relatively inexpensive structure is configured as the one that suppresses disadvantages such as poor distribution and the like due to air flow.

(1) The air conditioning case 12 includes the first housing 122 that houses the evaporator 16, the second housing 124 that houses the blower fan 18, and the fan connector 123 that connects the first housing 122 and the second housing 124. The cavity portion 52 is provided at a position between the fan connector 123 and the second housing 124. The fan connector 123 has a throttle shape in which the passage inside the fan connector 123 is narrowed in order to guide the air having passed through the evaporator 16 to the air suction side of the blower fan 18. Therefore, a space that does not contribute to air flow is formed at a position between the fan connector 123 and the second housing 124. Such a space is utilized to form the cavity portion 52 of the resonator 50. That is, the cavity portion 52 of the resonator 50 is formed at a position between the fan connector 123 and the second housing 124. According to the above, it is possible to suppress an increase in size of the vehicle air conditioning device 1 due to the addition of the resonator 50.

(2) The second housing 124 includes the fan outlet 125 through which the air blown out from the blower fan 18 passes. The communication portion 54 is provided at a portion of the fan outlet 125 adjacent to the cavity portion 52. Such a configuration effectively reduces noise generated on the air outlet side of the blower fan 18, and effectively prevents noise of the vehicle air conditioning device 1 from reaching the vehicle cabin.

(3) The blower fan 18 is a centrifugal fan that draws in air in the axial direction Dax along the axis CL of the shaft 181, and blows out the air in a direction away from the axis CL of the shaft 181. The fan outlet 125 is provided to overlap with the blower fan 18 in a direction away from the axis CL. When the blower fan 18 is a centrifugal fan, the fan outlet 125 protrudes in a direction away from the axis CL, which tends to form a space between the fan connector 123 and the second housing 124, which does not contribute to air flow. In order to make effective use of such a space, it is desirable that the cavity portion 52 of the resonator 50 be formed at a position between the fan connector 123 and the second housing 124.

(4) The partition member 56 includes the rib 561 that is provided on the air conditioning case 12. According to the above, the internal space of the cavity portion 52 is divided into multiple closed spaces 520 by a simple partition member 56 such as the rib 561 provided on the air conditioning case 12. Such a configuration contributes to the cost reduction of the vehicle air conditioning device 1.

(5) The rib 561 is provided on the second housing 124 side, and protrudes toward the first housing 122 side. In such manner, when the rib 561 is erected on the second housing 124 side, communication between adjacent closed spaces 520 is suppressed, at least on the second housing 124 side, making it easier to set the resonance frequency f of the resonance section R consisting of multiple closed spaces 520 and the through holes 541 to a target frequency. As a result, noise from the vehicle air conditioning device 1 is effectively suppressible.

(6) The communication portion 54 includes the multiple through holes 541 formed on the air conditioning case 12. According to the above, the cavity portion 52 of the resonator 50 and the air passage 120 can be communicated with each other via the simple communication portion 54 such as the through hole 541 or the like. Such a configuration contributes to the cost reduction of the vehicle air conditioning device 1.

(7) The resonator 50 has the multiple resonance portions R formed by the multiple closed spaces 520 and the multiple through holes 541. At least some of the multiple resonance portions R are configured to have a different resonance frequency f from the others. According to the above, it is possible to prevent noise of the vehicle air conditioning device 1 from reaching the vehicle cabin even when there are multiple types of noise with different frequencies.

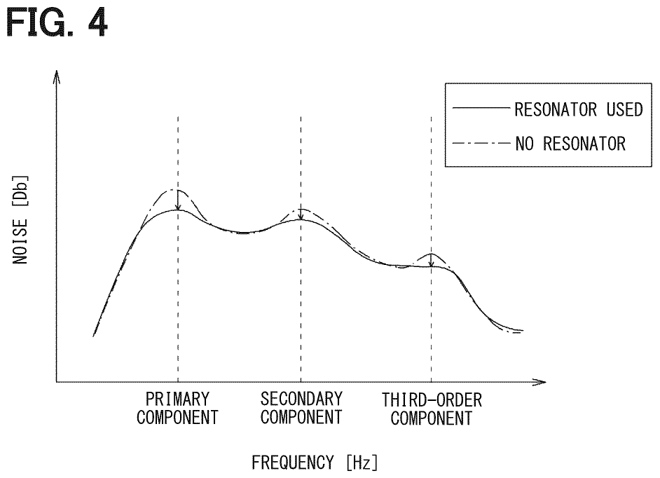

Specifically, the resonator 50 has the first resonating portion Ra1, the second resonating portion Ra2, and the third resonating portion Ra3 whose resonance frequencies f correspond to the frequencies of the primary, secondary, and third-order components of the NZ noise. According to the above, as shown in FIG. 4, the primary, secondary and third-order components of the NZ noise are appropriately suppressible by the resonator 50.

### Modification Example of the First Embodiment

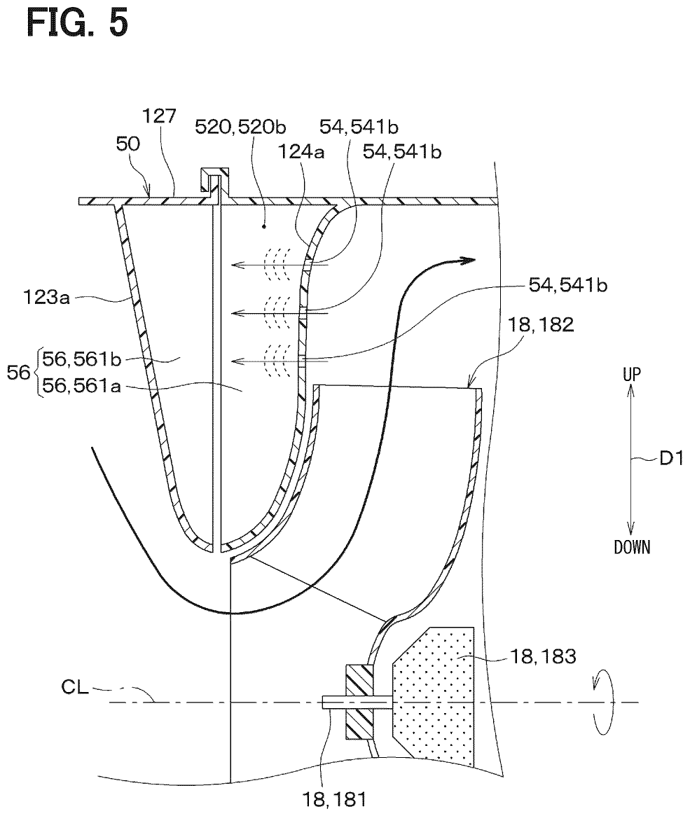

The rib 561 of the resonator 50 in the first embodiment is erected on the guide wall 124a so that the tip of the rib 561 abuts against the bell mouth 123a of the fan connector 123, but the configuration is not limited thereto. The rib 561 may be made of, for example, a first rib 561a located and standing on the bell mouth 123a of the fan connector 123 and a second rib 561b located and standing on the guide wall 124a, as shown in FIG. 5. It may be preferable that the rib 561 be erected on the guide wall 124a, but the configuration of the rib 561 is not limited thereto. The rib 561 may be located to stand on the bell mouth 123a of the fan connector 123 so that the tip of the rib 561 abuts against the guide wall 124a.

In the first embodiment, the resonance frequency f of the multiple resonance portions R is set to a desired frequency by changing the opening ratio of the multiple through holes 541 in the multiple resonance portions R, but the configuration is not limited to the above. For example, the resonance frequency f of the multiple resonance portions R may be set to a desired frequency by changing the hole diameters or the like of the multiple through holes 541 in the multiple resonance portions R.

### SECOND EMBODIMENT

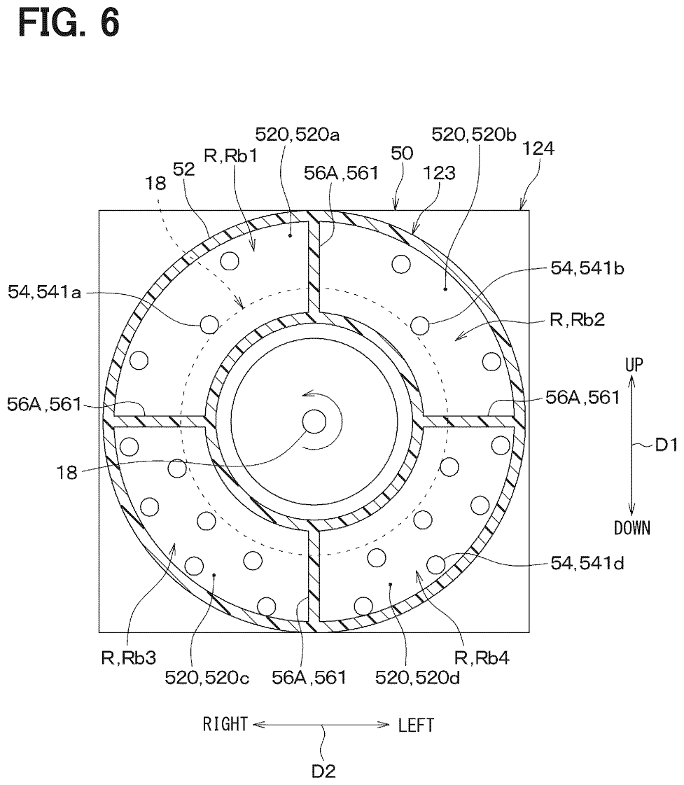

Next, the second embodiment will be described with reference to FIGS. 6 to 8. In the present embodiment, differences from the first embodiment will mainly be described.

As shown in FIG. 6, in a resonator 50 of the present embodiment, the internal space of a cavity portion 52 is divided into four closed spaces 520, namely, a first space 520a, a second space 520b, a third space 520c, and a fourth space 520d, by a partition member 56A formed in a shape of a “+ (cross)” character. Each of the four closed spaces 520 communicates with an air passage 120 via a communication portion 54. The partition member 56A includes ribs 561A that protrude in both an up-down direction D1 and a left-right direction D2.

The resonator 50 has four resonance portions R formed by the four closed spaces 520 and multiple through holes 541. Of the multiple resonance portions R, a pair of resonance portions R opposing each other in a predetermined direction are configured so that the difference between their respective resonance frequencies f is smaller than the difference between their respective resonance frequencies f of the other resonance portions R. The resonator 50 of the present embodiment is configured such that the difference in the resonance frequencies f between a pair of resonance portions R opposing each other in the left-right direction D2 among the multiple resonance portions R is smaller than the difference in the resonance frequencies f between vertically-adjacent resonance portions R. In the present embodiment, the predetermined direction is the left-right direction D2 when a vehicle air conditioning device 1 is mounted on a vehicle.

Specifically, the resonator 50 is provided with a first resonance portion Rb1, a second resonance portion Rb2, a third resonance portion Rb3, and a fourth resonance portion Rb4. The first resonance portion Rb1 is formed by a first space 520a and a through hole 541a. The second resonance portion Rb2 is formed by a second space 520b and a through hole 541b. The third resonance portion Rb3 is defined by a third space 520c and a through hole 541c. The fourth resonance portion Rb4 is defined by a fourth space 520d and a through hole 541d.

In the resonator 50, the first resonance portion Rb1 and the second resonance portion Rb2 are arranged to oppose each other in the left-right direction D2, and below them, the third resonance portion Rb3 and the fourth resonance portion Rb4 are arranged to oppose each other in the left-right direction D2. In the resonator 50, the first resonance portion Rb1 and the third resonance portion Rb3 are arranged to oppose each other in an up-down direction DR1, and the second resonance portion Rb2 and the fourth resonance portion Rb4 are arranged to oppose each other in the up-down direction DR1.

The resonator 50 is configured so that a resonance frequency f1 of the first resonance portion Rb1 and a resonance frequency f2 of the second resonance portion Rb2 are substantially the same frequency. Further, the resonator 50 is configured so that a resonance frequency f3 of the third resonance portion Rb3 and a resonance frequency f4 of the fourth resonance portion Rb4 are substantially the same frequency.

When an air blowing mode of the vehicle air conditioning device 1 is switched, an air passage changes, and the frequency characteristics of the noise also change. For example, in a face mode, in which ventilation air is blown toward the user's upper half of the body through a face opening 126d, low frequency noise tends to be more noticeable than in a foot mode, in which ventilation air is blown toward the user's lower half of the body through a foot opening 126e.

Taking the above into consideration, the opening ratios of the through holes 541a, 541b of the first resonance portion Rb1 and the second resonance portion Rb2 in the present embodiment are set so that the respective resonance frequencies f1, f2 correspond to the frequency of noise in the face mode. The through hole 541a of the first resonance portion Rb1 and the through hole 541b of the second resonance portion Rb2 may be arranged symmetrically in the left-right direction D2, or may be arranged asymmetrically in the left-right direction D2.

In addition, in the third resonance portion Rb3 and the fourth resonance portion Rb4 of the present embodiment, the opening ratios of the through holes 541c, 541d are set so that the respective resonance frequencies f3, f4 correspond to the frequency of noise in the foot mode. The through hole 541c of the third resonance portion Rb3 and the through hole 541d of the fourth resonance portion Rb4 may be arranged symmetrically in the left-right direction D2, or may be arranged asymmetrically in the left-right direction D2.

Basically, the opening ratio of each of the first resonance portion Rb1 and the second resonance portion Rb2 is smaller than the opening ratio of each of the third resonance portion Rb3 and the fourth resonance portion Rb4. However, this is not the case when the depths of the closed spaces 520 of the resonance portions Rb1, Rb2, Rb3, and Rb4 are different.

Others are the same as those in the first embodiment. The vehicle air conditioning device 1 of the present embodiment can obtain the same effects as the first embodiment, which are achieved by a configuration common to or equivalent to the first embodiment.

The vehicle air conditioning device 1 of the present embodiment also has the following features.

(1) In the multiple resonance portions R, a pair of resonance portions R opposing each other in a predetermined direction are configured so that the difference between their respective resonance frequencies f is smaller than the difference between their respective resonance frequencies f of the other resonance portions R. In such manner, by bringing the resonance frequencies f of a pair of resonance portions R opposing each other in a predetermined direction closer to each other, it is possible to suppress the expansion of noise distribution around a blower fan 18.

(2) The above-mentioned predetermined direction is the left-right direction D2 when the vehicle air conditioning device 1 is mounted on the vehicle. According to the above, the sound absorbing performance on the left and right sides of the resonator 50 becomes equivalent, thereby the noise distribution expanding toward the left and right sides of the blower fan 18 can be prevented.

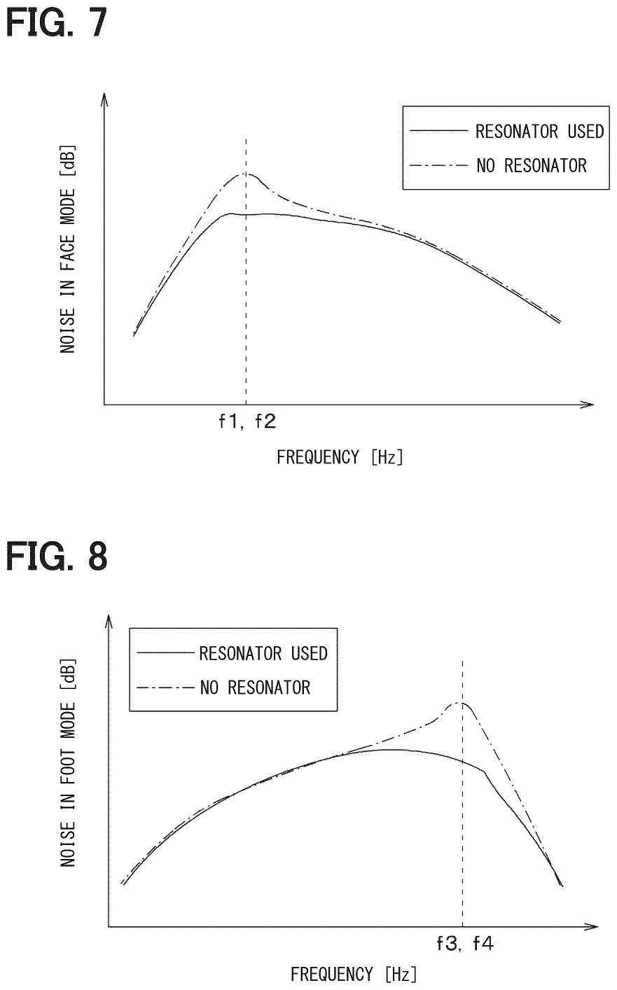

Specifically, the opening ratios of the through holes 541a, 541b of the first resonance portion Rb1 and the second resonance portion Rb2 are set so that the resonance frequencies f1, f2 of the first resonance portion Rb1 and the second resonance portion Rb2 correspond to the frequency of noise in the face mode. Therefore, for example, as shown in FIG. 7, the noise in the face mode is appropriately suppressible by the resonator 50.

Further, the opening ratios of the through holes 541c, 541d of the third resonance portion Rb3 and the fourth resonance portion Rb4 are set so that the respective resonance frequencies f3, f4 correspond to the frequency of noise in the foot mode. Therefore, for example, as shown in FIG. 8, the noise in the foot mode is appropriately suppressible by the resonator 50.

Further, the resonator 50 may be configured such that the resonance frequencies f1, f2 of the first resonance portion Rb1 and the second resonance portion Rb2 correspond to the frequency of noise in the foot mode, and the resonance frequencies f3, f4 of the third resonance portion Rb3 and the fourth resonance portion Rb4 correspond to the frequency of noise in the face mode.

Here, in the vehicle air conditioning device 1, the frequency characteristics of the noise change when, for example, an air intake mode is switched or a cooling/heating operation mode is switched. Therefore, the opening ratio of the through holes 541 of the multiple resonance portions R may be set for accommodating changes in the frequency characteristics of noise due to differences in the intake modes or the operation modes.

### Modification Example of Second Embodiment

The resonator 50 of the second embodiment is configured so that the difference in resonance frequencies f between a pair of resonance portions R opposing each other in the left-right direction D2 is smaller than the difference in resonance frequencies f between vertically-adjacent resonance portions R, but the configuration is not limited thereto. The resonator 50 may be configured so that the difference in resonance frequencies f between a pair of resonance portions R opposing each other in the up-down direction D1 is smaller than the difference in resonance frequencies f between adjacent resonance portions R on the left and right.

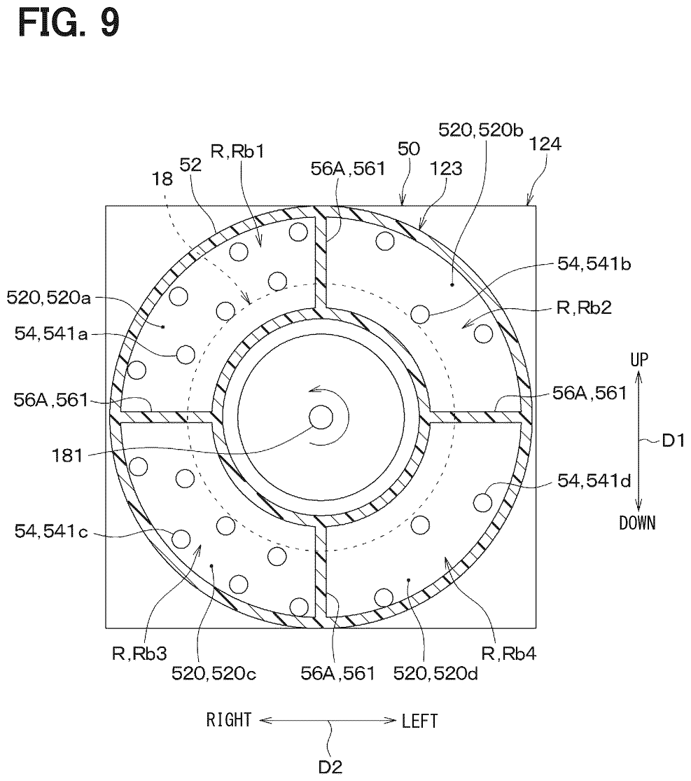

For example, as shown in FIG. 9, the opening ratios of the through holes 541b, 541d of the second resonance portion Rb2 and the fourth resonance portion Rb4 opposing each other in the up-down direction D1 may be set so that the respective resonance frequencies f2, f4 correspond to the frequency of noise in the face mode. Further, the opening ratios of the through holes 541a, 541c of the first resonance portion Rb1 and the third resonance portion Rb3 opposing each other in the up-down direction D1 may be set so that the respective resonance frequencies f1, f3 correspond to the frequency of noise in the foot mode.

According to the above, the sound absorbing performance of the resonator 50 becomes same in the upper and lower halves, so that the noise distribution expanding upward and downward from the blower fan 18 is preventable. Further, the resonator 50 may be configured such that the resonance frequencies f1, f3 of the first resonance portion Rb1 and the third resonance portion Rb3 correspond to the frequency of noise in the face mode, and the resonance frequencies f2, f4 of the second resonance portion Rb2 and the fourth resonance portion Rb4 correspond to the frequency of noise in the foot mode.

### THIRD EMBODIMENT

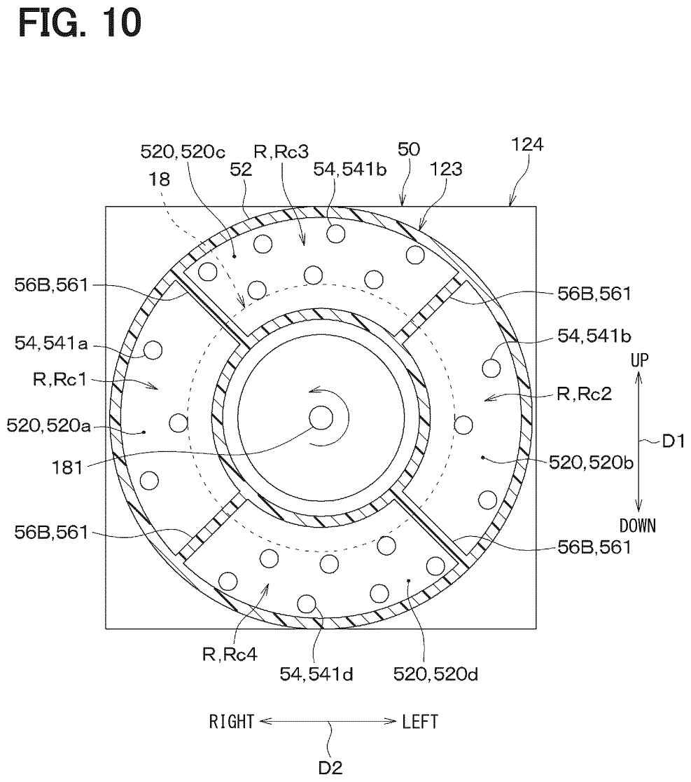

Next, the third embodiment will be described with reference to FIG. 10. In the present embodiment, differences from the second embodiment will mainly be described.

As shown in FIG. 10, in the present embodiment of a resonator 50, an internal space of a cavity portion 52 is divided into four closed spaces 520, namely, a first space 520a, a second space 520b, a third space 520c, and a fourth space 520d, by a partition member 56B formed in an “X” shape. Each of the four closed spaces 520 communicates with an air passage 120 via a communication portion 54. The partition member 56B includes a rib 561B that protrudes in directions intersecting both an up-down direction D1 and a left-right direction D2.

The resonator 50 has four resonance portions R formed by the four closed spaces 520 and multiple through holes 541. Among the multiple resonance portions R, the difference in resonance frequencies f between a pair of resonance portions R opposing each other in the up-down direction D1 and in the left-right direction D2 is configured to be smaller than the difference in resonance frequencies f between adjacent resonance portions R in a rotation direction of a blower fan 18. Specifically, the resonator 50 is provided with a first resonance portion Rc1, a second resonance portion Rc2, a third resonance portion Rc3, and a fourth resonance portion Rc4.

The resonator 50 has the first resonance portion Rc1 and the second resonance portion Rc2 arranged to oppose each other in the left-right direction D2, with the blower fan 18 in between, and the third resonance portion Rc3 and the fourth resonance portion Rc4 arranged to oppose each other in the up-down direction D1, with the blower fan 18 interposed therebetween.

The resonator 50 is configured so that a resonance frequency f1 of the first resonance portion Rc1 and a resonance frequency f2 of the second resonance portion Rc2 are substantially the same frequency. Further, the resonator 50 is configured so that a resonance frequency f3 of the third resonance portion Rc3 and a resonance frequency f4 of the fourth resonance portion Rc4 are substantially the same frequency. Specifically, the opening ratios of the through holes 541a, 541b of the first resonance portion Rc1 and the second resonance portion Rc2 are set so that the resonance frequencies f1, f2 of the first resonance portion Rc1 and the second resonance portion Rc2 correspond to the frequency of noise in a face mode. Further, in the third resonance portion Rc3 and the fourth resonance portion Rc4 of the present embodiment, the opening ratios of the through holes 541c, 541d are set so that the respective resonance frequencies f3, f4 correspond to the frequency of noise in a foot mode.

Others are the same as those in the second embodiment. A vehicle air conditioning device 1 of the present embodiment can achieve the same effects as the second embodiment, which are achieved by a configuration common to or equivalent to the first embodiment.

The vehicle air conditioning device 1 of the present embodiment also has the following features.

(1) The resonator 50 is configured so that the difference in resonance frequencies f between a pair of resonance portions R opposing each other in the up-down direction D1 and the left-right direction D2 is smaller than the difference in resonance frequencies f between adjacent resonance portions R in the rotation direction of the blower fan 18.

According to the above, the sound absorbing performance of the resonator 50 is equivalent above and below and to the left and right, so that the noise distribution expanding upward and downward and to the left and right of the blower fan 18 is preventable. Further, the resonator 50 may be configured such that the resonance frequencies f1, f2 of the first resonance portion Rc1 and the second resonance portion Rc2 correspond to the frequency of noise in the foot mode, and the resonance frequencies f3, f4 of the third resonance portion Rc3 and the fourth resonance portion Rc4 correspond to the frequency of noise in the face mode.

(2) Of the multiple resonance portions R, a pair of resonance portions R opposing each other across the blower fan 18 are configured so that the difference in their respective resonance frequencies f is smaller than the difference in their respective resonance frequencies f with the other resonance portions R. In such manner, by bringing the resonance frequencies f of a pair of resonance portions R opposing each other across the blower fan 18 closer to each other, the expansion of noise distribution around the blower fan 18 is suppressible.

Here, when the blower fan 18 is a centrifugal fan, the air blown out from the blower fan 18 contains a swirling component in the rotation direction of the blower fan 18, the frequency characteristics of the noise may change in the rotation direction of the blower fan 18. Therefore, if the resonance frequencies f of the multiple resonance portions R are different from each other, there is a risk that the noise distribution will expand in the rotation direction of the blower fan 18.

However, in the resonator 50 of the present embodiment, the resonance frequencies f of a pair of resonance portions R opposing each other across the blower fan 18 are brought close to each other, thereby the expansion of noise distribution in the rotation direction of the blower fan 18 is suppressible.

### Modification Example of Third Embodiment

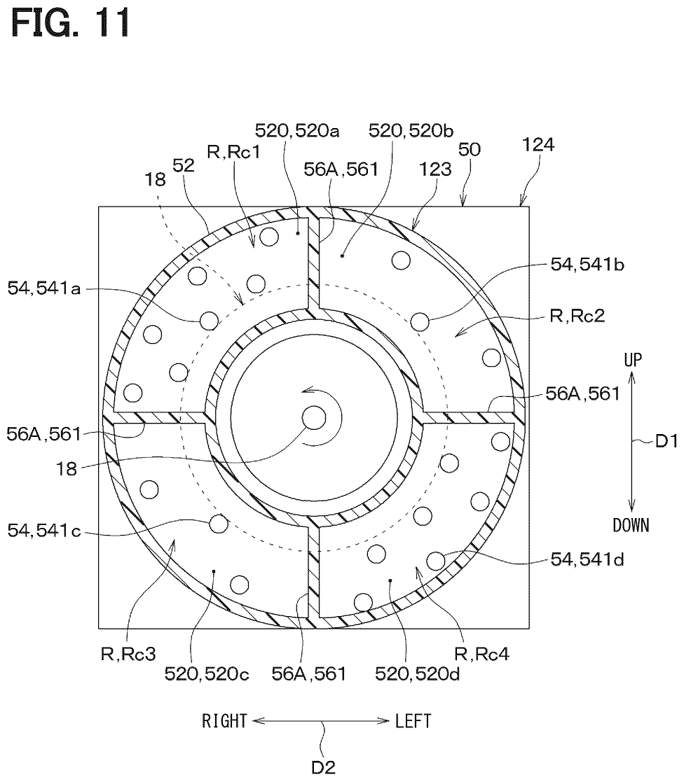

The resonator 50 of the third embodiment is configured so that the difference in resonance frequencies f between a pair of resonance portions R opposing each other in the up-down direction D1 and the left-right direction D2 is smaller than the difference in resonance frequencies f between adjacent resonance portions R in the rotation direction of the blower fan 18, but the configuration is not limited thereto. The resonator 50 may be configured, for example as shown in FIG. 11, so that the difference in resonance frequencies f between a pair of resonance portions R opposing each other in intersecting directions, i.e., intersecting with the up-down direction D1 and the left-right direction D2, is smaller than the difference in resonance frequencies f between adjacent resonance portions R in the rotation direction of the blower fan 18.

### FOURTH EMBODIMENT

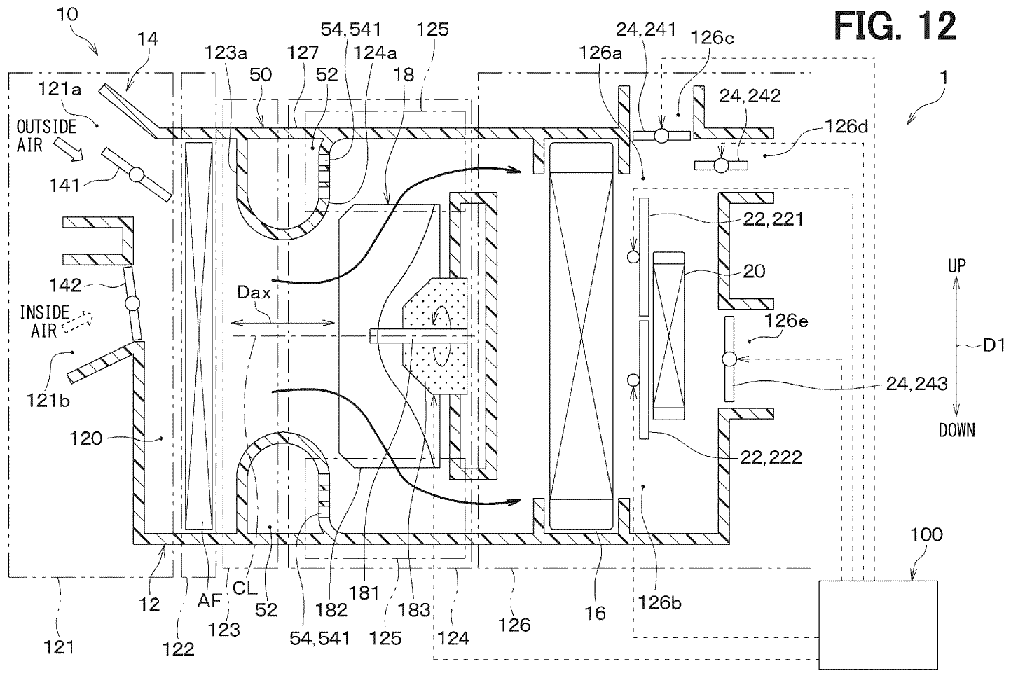

Next, the fourth embodiment will be described with reference to FIG. 12. In the present embodiment, differences from the first embodiment will mainly be described.

As shown in FIG. 12, a first housing 122 is connected to a downstream side of the air flow of an air inlet 121. An air filter AF is accommodated inside the first housing 122 instead of an evaporator 16. The air filter AF has a flat rectangular parallelepiped shape. The first housing 122 is configured as a rectangular tube having a substantially rectangular outer shape, for accommodating the air filter AF.

A second housing 124 is connected to a downstream side of the air flow of the first housing 122 via a fan connector 123. A blower fan 18 is accommodated inside the second housing 124. Similar to the first housing 122, the second housing 124 is configured as a rectangular tube having a substantially rectangular outer shape.

The fan connector 123 is a portion that guides the air that has passed through the air filter AF to an air suction side of the blower fan 18. The fan connector 123 is configured as a rectangular tube with a roughly rectangular portion at a connection portion with the first housing 122, and changes from the rectangular tube to a shape closer to a cylinder as it approaches the second housing 124. The fan connector 123 has an inner passage that narrows toward the downstream side and has a throttle shape.

An air outlet 126 is connected to a downstream side of the air flow of the second housing 124. The evaporator 16 and a heater core 20 are arranged in the air outlet 126. The evaporator 16 and the heater core 20 are arranged downstream of the air flow of the blower fan 18.

The evaporator 16 is arranged upstream of the heater core 20 in the air flow direction. The evaporator 16 is arranged in the air outlet 126 so that the air blown out from the blower fan 18 passes through the evaporator 16.

The heater core 20 is arranged in the air outlet 126 so that cool air bypass passages 126a, 126b are formed above and below the heater core 20, through which the ventilation air flows to bypass the heater core 20. Further, in the air outlet 126, an air mix door 22 is arranged at a position between the evaporator 16 and the heater core 20.

In an air conditioning case 12 configured in such manner, a space that does not contribute to air flow is formed at a position between the fan connector 123 and the second housing 124. Such a space is utilized to form a cavity portion 52 of the resonator 50. A communication portion 54 of the resonator 50 is provided at a position adjacent to the cavity portion 52 in a fan outlet 125 of the second housing 124. Specifically, the communication portion 54 is formed in a portion of a guide wall 124a that is arranged on an outer side of the blower fan 18. The communication portion 54 in the present embodiment is constituted by multiple through holes 541 provided on the air conditioning case 12. The multiple through holes 541 penetrate the guide wall 124a from the outside to the inside.

Others are the same as those in the first embodiment. A vehicle air conditioning device 1 of the present embodiment can obtain the same effects as the first embodiment, which are achieved by a configuration common to or equivalent to the first embodiment. That is, even in a configuration in which the evaporator 16 is arranged downstream of the air flow of the blower fan 18, as in the vehicle air conditioning device 1 of the present embodiment, noise is effectively suppressible by the resonator 50, as in the first embodiment.

Specifically, the vehicle air conditioning device 1 of the present embodiment has the following features. (1) The vehicle air conditioning device 1 includes the air conditioning case 12 that defines the air passage 120 for the ventilation air, the blower fan 18 that is arranged inside the air conditioning case 12, and the resonator 50 that is provided outside the air passage 120. The resonator 50 includes the cavity portion 52 having a predetermined volume and the communication portion 54 that communicates the cavity portion 52 with the downstream side of the air flow of the blower fan 18 in the air passage 120. The cavity portion 52 is provided with a partition member 56 that divides the internal space of the cavity portion 52 into multiple closed spaces 520, and each of the multiple closed spaces 520 is in communication with the air passage 120 via the communication portion 54.

According to the above, the resonator 50 is arranged adjacent to the air passage 120 inside the air conditioning case 12, so that noise from the vehicle air conditioning device 1 is prevented from reaching the air-conditioning target space. In particular, since the internal space of the cavity portion 52 is divided into the multiple closed spaces 520, the noise of the vehicle air conditioning device 1 is prevented from reaching the air-conditioning target space, even in case where multiple types of noise with different frequencies are present. Further, since the resonator 50 is arranged so as to reduce noise generated in a section of the air passage 120 from the blower fan 18 to the air-conditioning target space, the resonator 50 can effectively suppress noise generated downstream of the air flow of the blower fan 18. For example, the resonator 50 of the present embodiment may be configured in a form different from that of the first embodiment, as in the second and third embodiments.

### OTHER EMBODIMENTS

Although representative embodiments according to the present disclosure are described above, the present disclosure is not limited to the above-described embodiments, and various modifications can be made, for example, as follows.

In the above embodiment, specific examples are given as examples of the components of the cabin air conditioning unit 10, but the components are not limited to these, and at least a part of the components may be different. For example, the air cooler may be configured not by the evaporator 16 but by a cooler core that exchanges heat between a low-temperature heat medium and the ventilation air. The blower fan 18 need not be a centrifugal fan, but may be a mixed flow fan or the like. The air heater may be configured as an electric heater or the like instead of the heater core 20. The air heater and the like are not essential components of the vehicle air conditioning device 1 and may be omitted. In the fourth embodiment, the air filter AF, the air cooler, and the like are not essential components and may be omitted.

As in the above-described embodiment, it is desirable for the cavity portion 52 of the resonator 50 to be provided at a position between the fan connector 123 and the second housing 124, but such a configuration is not essential, and the cavity portion 52 may be provided at a different position. Further, the cavity portion 52 may be divided into two or five or more closed spaces 520 by the partition member 56.

As in the above-described embodiment, it is desirable for the communication portion 54 of the resonator 50 to be provided in a position adjacent to the cavity portion 52 in the fan outlet 125, but such a configuration is not essential, and the communication portion 54 may be provided in a different position. Further, the communication portion 54 has been exemplified as being composed of the multiple through holes 541 provided in the air conditioning case 12, but such a configuration is not essential, and the communication portion 54 may be composed of, for example, a communication pipe that connects the air passage 120 and the inside of the cavity portion 52.

As in the above-described embodiment, the partition member 56 of the resonator 50 is configured with the rib 561 molded integrally with the air conditioning case 12, but such a configuration is not a limited one. The partition member 56 may be configured, for example, by a rib 561 that is separate from the air conditioning case 12. The partition member 56 extends in a direction away from the axis CL of the blower fan 18, but such a configuration is not a limited one, and the partition member 56 may be composed of, for example, a circular ring-shaped rib 561 centered on the axis CL of the blower fan 18.

Further, it is desirable that the adjacent closed spaces 520 of the resonator 50 are air-tightly separated by the partition member 56, but such a configuration is not a limited one, and the adjacent closed spaces 520 may be connected via a small gap between the air conditioning case 12 and the partition member 56.

As in the above embodiment, it is preferable that the resonator 50 is configured so that at least some of the multiple resonance portions R have a resonance frequency f different from the others, but such a configuration is not essential.

In the above embodiment, an example has been described in which the air conditioning device of the present disclosure is applied to the vehicle air conditioning device 1, but the application of the air conditioning device of the present disclosure is not limited thereto. The air conditioning device of the present disclosure can be applied to a stationary air conditioning device, a portable air conditioning device, or the like.

In the embodiments described above, it is needless to say that the elements configuring the embodiments are not necessarily essential except in the case where those elements are clearly indicated to be essential in particular, the case where those elements are considered to be obviously essential in principle, and the like.

In the embodiments described above, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments described above, when referring to the shape, positional relationship, and the like of a component and the like, it is not limited to the referred-to shape, positional relationship, and the like, except for the case where it is specifically specified, the case where it is fundamentally limited to a specific shape, positional relationship, and the like.

### Various Aspects of Present Disclosure

### [First Aspect]

An air conditioning device includes: an air conditioning case (12) defining an air passage (120) through which a ventilation air flows to an air-conditioning target space; an air cooler (16) arranged inside the air conditioning case to cool the ventilation air by absorbing heat from the ventilation air; a blower fan (18) arranged inside the air conditioning case on a downstream side of an air flow of the air cooler, to generate an air flow passing through the air cooler; and a resonator (50) provided outside of the air passage. The resonator (50) includes a cavity portion (52) having a predetermined volume, and a communication portion (54) through which the cavity portion (52) and the air passage (120) communicate with each other. The cavity portion (52) is provided with a partition member (56, 56A, 56B) that divides an internal space of the cavity portion (52) into multiple closed spaces, and each of the multiple closed spaces is configured to communicate with the air passage (120) via the communication portion (54).

### [Second Aspect]

An air conditioning device includes: an air conditioning case (12) defining an air passage (120) through which a ventilation air flows to an air-conditioning target space; a blower fan (18) arranged inside the air conditioning case (12) to generate an air flow passing through the air passage (120); and a resonator (50) provided outside the air passage (120). The resonator (50) includes a cavity portion (52) having a predetermined volume, and a communication portion (54) through which the cavity portion (52) communicates with at least a downstream side of the air flow of the blower fan (18) in the air passage (120). The cavity portion (52) is provided with a partition member (56, 56A, 56B) that divides an internal space of the cavity portion (52) into multiple closed spaces, and each of the multiple closed spaces is configured to communicate with the air passage (120) via the communication portion (54).

### [Third Aspect]

In the air conditioning device according to first aspect, the air conditioning case includes: a first housing (122) that houses the air cooler; a second housing (124) that houses the blower fan; and a fan connector (123) that connects the first housing and the second housing, and the cavity portion is provided at a position between the fan connector and the second housing.

### [Fourth Aspect]

In the air conditioning device according to third aspect, the second housing includes a fan outlet (125) through which the air blown out from the blower fan passes, and the communication portion is provided at a portion of the fan outlet adjacent to the cavity portion.

### [Fifth Aspect]

In the air conditioning device according to fourth aspect, the blower fan is a centrifugal fan configured to draw air in an axial direction along an axis of a shaft (181) of the blower fan, and to blow out air in a direction away from the axis of the shaft, and the fan outlet is provided to overlap with the blower fan in the direction away from the axis of the shaft.

### [Sixth Aspect]

In the air conditioning device according to any one of third to fifth aspects, the partition member includes a rib (561) provided in the air conditioning case.

### [Seventh Aspect]

In the air conditioning device according to sixth aspect, the rib is provided on a second housing side and protrudes towards the first housing.

### [Eighth Aspect]

In the air conditioning device according to any one of first to seventh aspects, the communication portion includes multiple through holes (541) provided at the air conditioning case.

### [Ninth Aspect]

In the air conditioning device according to eighth aspect, the resonator has multiple resonance portions configured by multiple closed spaces and multiple through holes, and at least a part of the multiple resonance portions are configured to have a resonance frequency different from other resonance portions.

### [Tenth Aspect]

In the air conditioning device according to ninth aspect, among the multiple resonance portions, each pair of the resonance portions opposing each other in a predetermined direction are configured so that a difference between resonance frequencies of the paired resonance portions is smaller than a difference between resonance frequencies of non-paired resonance portions.

### [Eleventh Aspect]

In the air conditioning device according to tenth aspect, the air conditioning device is applied to an air conditioning device mounted on a vehicle, and the predetermined direction is at least one of an up-down direction or a left-right direction in a state in which the air conditioning device is mounted on the vehicle.

### [Twelfth Aspect]

In the air conditioning device according to any one of ninth to eleventh aspects, among the multiple resonance portions, a pair of the resonance portions opposing each other across the blower fan are configured to have a difference between resonance frequencies of the pair of resonance portions, which is smaller than a difference between resonance frequencies of non-paired resonance portions other than the pair of resonance portions.

### [Thirteenth Aspect]

In the air conditioning device according to any one of first to twelfth aspects, the resonator is arranged at an upstream side of the blower fan in the air flow, and the communication portion is open toward downstream in the air flow to cause each of the multiple closed spaces of the resonator to communicates with the downstream side of the air flow of the blower fan in the air passage through the communication portion while without directly communicating with an upstream side of the air flow of the blower fan through the communication portion.

What is claimed is:

1. An air conditioning device comprising:
an air conditioning case defining an air passage through which a ventilation air flows to an air-conditioning target space;
an air cooler arranged inside the air conditioning case to cool the ventilation air by absorbing heat from the ventilation air;
a blower fan arranged inside the air conditioning case on a downstream side of an air flow of the air cooler, to generate an air flow passing through the air cooler; and
a resonator provided outside of the air passage, wherein
the resonator includes a cavity portion having a predetermined volume, and a communication portion through which the cavity portion and the air passage communicate with each other, and
the cavity portion is provided with a partition member that divides an internal space of the cavity portion into multiple closed spaces, and each of the multiple closed spaces is configured to communicate with the air passage via the communication portion.

2. An air conditioning device comprising:
an air conditioning case defining an air passage through which a ventilation air flows to an air-conditioning target space;
a blower fan arranged inside the air conditioning case to generate an air flow passing through the air passage; and
a resonator provided outside the air passage, wherein
the resonator includes a cavity portion having a predetermined volume, and a communication portion through which the cavity portion communicates with at least a downstream side of the air flow of the blower fan in the air passage, and
the cavity portion is provided with a partition member that divides an internal space of the cavity portion into multiple closed spaces, and each of the multiple closed spaces is configured to communicate with the air passage via the communication portion.

3. The air conditioning device according to claim 1, wherein
the air conditioning case includes: a first housing that houses the air cooler; a second housing that houses the blower fan; and a fan connector that connects the first housing and the second housing, and
the cavity portion is provided at a position between the fan connector and the second housing.

4. The air conditioning device according to claim 3, wherein
the second housing includes a fan outlet through which air blown out from the blower fan passes, and
the communication portion is provided at a portion of the fan outlet adjacent to the cavity portion.

5. The air conditioning device according to claim 4, wherein,
the blower fan is a centrifugal fan configured to draw air in an axial direction along an axis of a shaft of the blower fan, and to blow out air in a direction away from the axis of the shaft, and
the fan outlet is provided to overlap with the blower fan in the direction away from the axis of the shaft.

6. The air conditioning device according to claim 3, wherein
the partition member includes a rib provided in the air conditioning case.

7. The air conditioning device according to claim 6, wherein
the rib is provided on a second housing side to protrude towards the first housing.

8. The air conditioning device according to claim 1, wherein
the communication portion includes multiple through holes provided at the air conditioning case.

9. The air conditioning device according to claim 8, wherein
the resonator has multiple resonance portions configured by multiple closed spaces and multiple through holes, and
at least a part of the multiple resonance portions are configured to have a resonance frequency different from other resonance portions.

10. The air conditioning device according to claim 9, wherein
among the multiple resonance portions, each pair of the resonance portions opposing each other in a predetermined direction are configured so that a difference between resonance frequencies of the paired resonance portions is smaller than a difference between resonance frequencies of non-paired resonance portions.

11. The air conditioning device according to claim 10, wherein
the air conditioning device is applied to an air conditioning device mounted on a vehicle, and
the predetermined direction is at least one of an up-down direction or a left-right direction in a state in which the air conditioning device is mounted on the vehicle.

12. The air conditioning device according to claim 9, wherein
among the multiple resonance portions, a pair of the resonance portions opposing each other across the blower fan are configured to have a difference between resonance frequencies of the pair of resonance portions, which is smaller than a difference between resonance frequencies of non-paired resonance portions other than the pair of resonance portions.

13. The air conditioning device according to claim 1, wherein
the resonator is arranged at an upstream side of the blower fan in the air flow, and
the communication portion is provided with a plurality of through holes open toward downstream in the air flow to cause each of the multiple closed spaces of the resonator to communicates with the downstream side of the air flow of the blower fan in the air passage through the through holes while without directly communicating with an upstream side of the air flow of the blower fan through the through holes.
